(19) United States
(12) Patent Application Publication
(10) Pub. No.: US 2026/0172888 A1
(43) Pub. Date: Jun. 18, 2026

(54) APPARATUS AND METHOD FOR MECHANISM ENHANCEMENT FOR WIFI

(71) Applicant: Intel Corporation, Santa Clara, CA (US)

(72) Inventors: Dibakar Das, Hillsboro, OR (US); Dmitry Akhmetov, Hillsboro, OR (US); Danny Alexander, Neve Efraim Monoson (IL); Danny Ben-Ari, Hasharon Hatichon (IL); Laurent Cariou, Milizac (FR); Po-kai Huang, San Ramon, CA (US)

(73) Assignee: Intel Corporation, Santa Clara, CA (US)

(21) Appl. No.: 19/417,281

(22) Filed: Dec. 11, 2025

Related U.S. Application Data
(60) Provisional application No. 63/733,163, filed on Dec. 12, 2024.

(51) Int. Cl. H04W 28/02

(52) U.S. Cl. CPC H04W 28/0268

(57) ABSTRACT

Provided herein is apparatus and method for mechanism enhancement for WiFi. An apparatus for a non Access Point (non-AP) Station (STA), comprising: interface circuitry; and processor circuitry coupled with the interface circuitry, wherein the processor circuitry is to: encode a first frame for transmission to an AP associated with the non-AP STA via the interface circuitry, wherein the first frame is to indicate an extended Queue size for a Traffic Identifier (TID) to request a resource assigned for a traffic corresponding to the TID; decode a second frame received from the AP via the interface circuitry in response to the first frame to obtain the resource assigned for the traffic; and cause transmission of the traffic to the AP with the assigned resource. Other embodiments are also claimed and described.

### CROSS-REFERENCE TO RELATED APPLICATION

The present disclosure claims priority to U.S. Provisional Application No. 63/733,163, entitled “MECHANISM TO ENABLE HIGH-PRIORITY ENHANCED DISTRIBUTED CHANNEL ACCESS THOUGH STATION DEVICE TO ACCESS POINT NEGOTIATION” and filed on Dec. 12, 2024, which is incorporated herein by reference in its entirety.

### TECHNICAL FIELD

Embodiments of the present disclosure generally relate to wireless communication, and in particular to apparatus and method for mechanism enhancement for WiFi.

### BACKGROUND ART

Wireless devices are becoming widely prevalent and are increasingly requesting access to wireless channels. The Institute of Electrical and Electronics Engineers (IEEE) is developing one or more standards to improve wireless performance.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 is a network diagram illustrating an example network environment in accordance with one or more example embodiments of the present disclosure.

FIG. 2 is a flowchart of a method for signaling extended BSR in accordance with one or more example embodiments of the present disclosure.

FIG. 3 is a flowchart of a method for signaling extended BSR in accordance with one or more example embodiments of the present disclosure.

FIG. 4 is a flowchart of a method for HIP EDCA mechanism enhancement in accordance with one or more example embodiments of the present disclosure.

FIG. 5 is a flowchart of a method for HIP EDCA mechanism enhancement in accordance with one or more example embodiments of the present disclosure.

FIG. 6 illustrates a functional diagram of an exemplary communication station that may be suitable for use as a user device, in accordance with one or more example embodiments of the present disclosure.

FIG. 7 illustrates a block diagram of an example machine upon which any of one or more techniques (e.g., methods) may be performed, in accordance with one or more example embodiments of the present disclosure.

FIG. 8 is a block diagram of a radio architecture in accordance with some examples.

FIG. 9 illustrates an example front-end module circuitry for use in the radio architecture of FIG. 8, in accordance with one or more example embodiments of the present disclosure.

FIG. 10 illustrates an example radio IC circuitry for use in the radio architecture of FIG. 8, in accordance with one or more example embodiments of the present disclosure.

FIG. 11 illustrates an example baseband processing circuitry for use in the radio architecture of FIG. 8, in accordance with one or more example embodiments of the present disclosure.

### DETAILED DESCRIPTION OF EMBODIMENTS

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

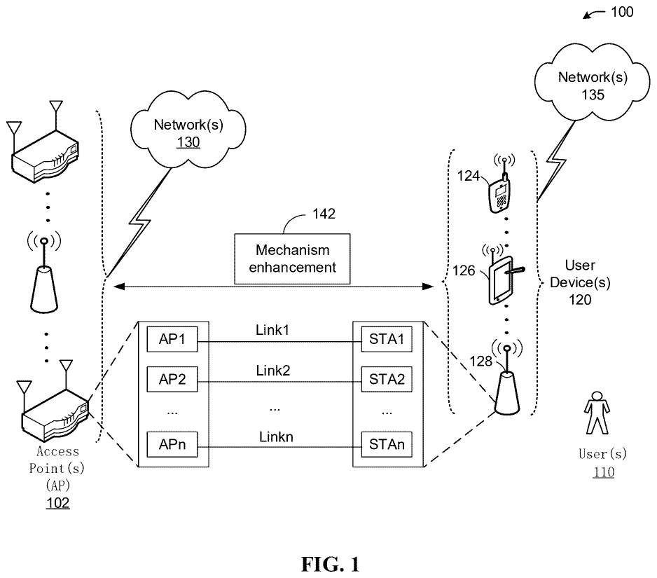

FIG. 1 is a network diagram illustrating an example network environment according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

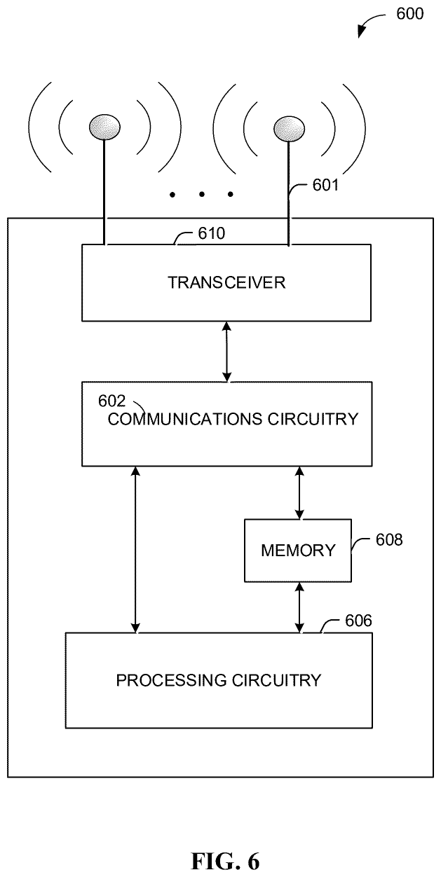

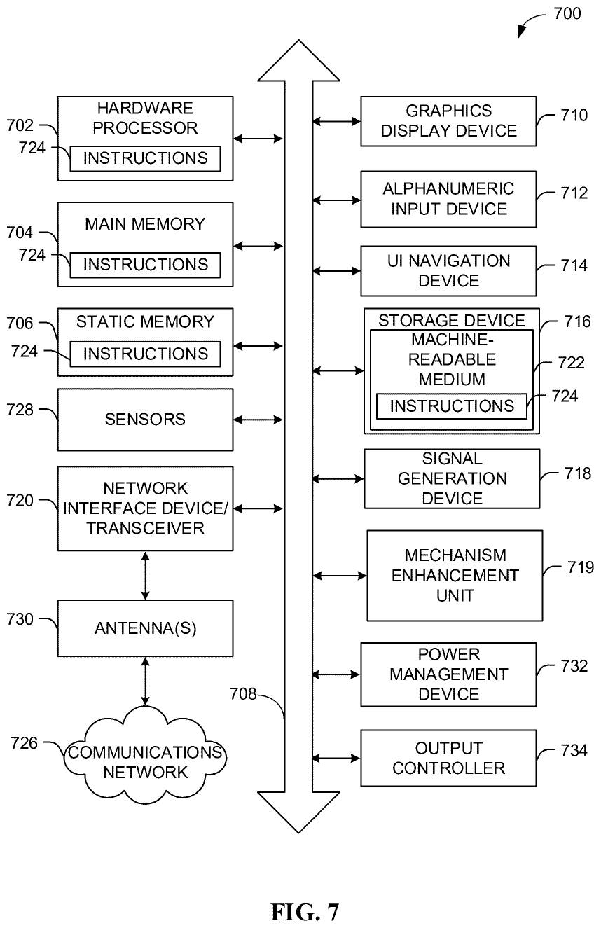

In some embodiments, the user devices 120 and the AP 102 may include one or more computer systems similar to that of the functional diagram of FIG. 6 and/or the example machine/system of FIG. 7.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook^{TM} computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement a mechanism enhancement 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

It is realized in this present disclosure that, in 802.11bn, there is a need to define a way for non-AP STAs to signal extended Buffer Status Report (BSR) than possible using baseline methods.

Example embodiments of the present disclosure relate to systems, methods, and apparatus for signaling extended BSR.

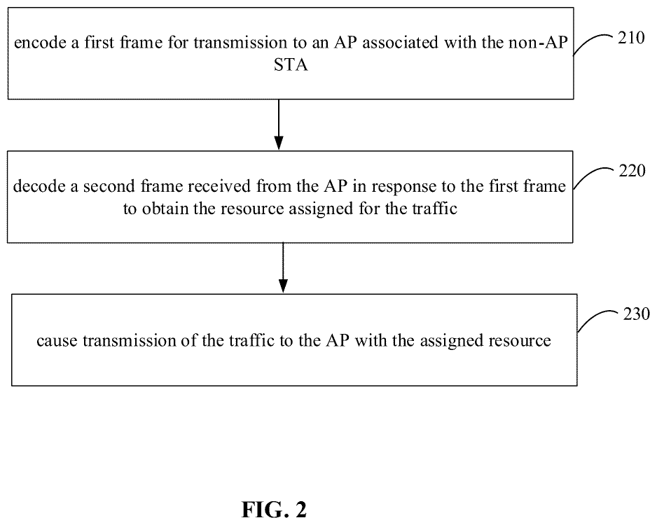

FIG. 2 is a flowchart of a method 200 for signaling extended BSR in accordance with one or more example embodiments of the present disclosure. The method 200 may be performed by a non-AP STA. As shown, the method 200 may include operations 210-230.

At 210, a first frame is encoded for transmission to an AP associated with the non-AP STA. The first frame is to indicate an extended Queue size for a Traffic Identifier (TID) to request a resource assigned for a traffic corresponding to the TID. At 220, a second frame received from the AP in response to the first frame is decoded to obtain the resource assigned for the traffic. At 230, the traffic is caused to be transmitted to the AP with the assigned resource.

In some embodiments, the first frame may include a first field to indicate an extended Unscaled Value (UV) corresponding to the TID, and a second field to indicate the TID and a Scaling Factor (SF). The extended Queue size for the TID may be based on the extended UV and the SF. The TID is to identify the traffic. For example, different TIDs may identify different traffic. In an example, the extended Queue size may be equal to a production of the extended UV and a value corresponding to the SF (e.g., SF=3 refers to 32768 octets, or the like). A baseline UV may include for example, 3 bits to represent 0 to 7, while an extended UV may include for example 8 bits to represent 0 to 255.

For example, a new A-Control field may be used to signal extended BSR size. In particular, the QoS Control field in medium access control (MAC) header of an MAC Protocol Data Units (MPDU) will signal the TID as well as the SF and UV value in the Queue Size field. A new A-Control field in the same MAC header will contain an extended UV value when the reported queue size is greater than what can be signaled using just the QoS Control field (˜2 MB). For example, if the extended UV has 8 bits, then with Scaling factor indicating 32,768, the queue size can be signaled up to 12 MB.

However, the above approach is problematic because the A-Control field is not self-contained but requires the associated AP to consider the value of the QoS Control field. If there are multiple TIDs in the same Aggregated MPDU (A-MPDU), then it doesn't work.

In some embodiments, the first frame may include a first field to indicate the TID and an extended UV corresponding to the TID and a second field to indicate the TID and an SF. The extended Queue size for the TID may be based on the extended UV and the SF. This approach can include both the TID and corresponding extended UV within a same filed and include both the TID and the SF within another field of the same frame. In some embodiments, the first frame will be used in a unicast frame from a non-AP STA to AP.

For example, a TID field (e.g., 3 or 4 bits or any other field size) may be added within the new A-Control field so that the same new A-Control field can be added to all MPDUs, potentially containing different TIDs in the AMPDU while also allowing the receiver to determine the queue size for that particular TID from the QoS Control field. In some embodiments, the new A-Control field may reuse an existing Control ID value without creating any disambiguates if both the AP and STA support this new A-Control feature.

In comparison, in some embodiments, the first frame is to indicate the extended Queue size for the TID and the TID within a single field. That is, the extended Queue size for the TID can be determined from a single field of the first frame. Some different options will be described below.

In some embodiments, the single field may include a TID subfield to indicate the TID, an extended UV subfield to indicate an extended UV corresponding to the TID, and an SF subfield to indicate an SF. The extended Queue size for the TID may be based on the extended UV and the SF. For example, a new (or redefine an existing) A-Control field may be used to signal the (TID, Scaling Factor, extended Unscaled Value) information.

In some embodiments, the single field may include a TID subfield to indicate the TID and an airtime subfield to indicate an airtime corresponding to the TID. The extended Queue size for the TID may be based on the airtime. For example, instead of signaling the queue size information directly, the signaling could piggy-back on the design of the P2P-BSR A-Control field by reporting the airtime and TID. The queue size can be derived by the AP from airtime by using some spec-defined data-rate.

In some embodiments, the single field may include a TID subfield to indicate the TID, a UV subfield to indicate a UV corresponding to the TID, and an SF subfield to indicate a scaled up SF. The extended Queue size for the TID may be based on the UV and the scaled up SF. In these embodiments, the existing Scaling Factor values in the Queue Size field may be simply scaled up to cover larger values (e.g., SF=3 signal N*32768 octets as opposed to 32768 octets in baseline). While this may reduce granularity of reporting, since the usage is expected to be anyway for high data rates, this should not matter much. In some embodiments, the new Scaling Factor values (e.g., N*32768) may be always used between an AP and STA if they have indicated capability to support this during discovery and/or association. Alternatively, in some embodiments, the Scaling Factor values may be used between an AP and STA if they are both capable and only if the MPDU contains some additional signaling elsewhere (e.g., using 1 currently reserved bit in an UPH A-Control field included within that MPDU).

In some embodiments, the single field may include a TID subfield to indicate the TID, a UV subfield to indicate a UV corresponding to the TID, and an SF subfield to indicate an SF. The extended Queue size for the TID may be based on an unspecified combination of the UV and the SF. In some embodiments, this may be STA capability and indicated to the AP during association process. For example, Scaling Factor value 3 and UV value 63 (Table 9-14 Queue size subfield encoding) that are currently used to indicate queue size as “unknown or unspecified” to indicate some larger value of queue size. In such a case, combination 3/62 would mean 2147238<Queue Size (QS)<“new large value” and combination 3/63 would mean QS>“new large value”. For example, the new large value may be a double of 2147238.

In some embodiments, the first frame may include a data frame. In some embodiments, the first frame may include a management frame. For example, a new management (Mgt) frame may be defined to report the extended BRS. The Mgt frame may be sent unicast (unsolicited or solicited) or aggregated with QoS Data frames.

In some embodiments, a plurality of MPDUs may be aggregated to obtain an A-MPDU. At least one of the plurality of MPDUs is in the format of the first frame as described above. Then the non-AP STA may transmit the A-MPDU to the AP.

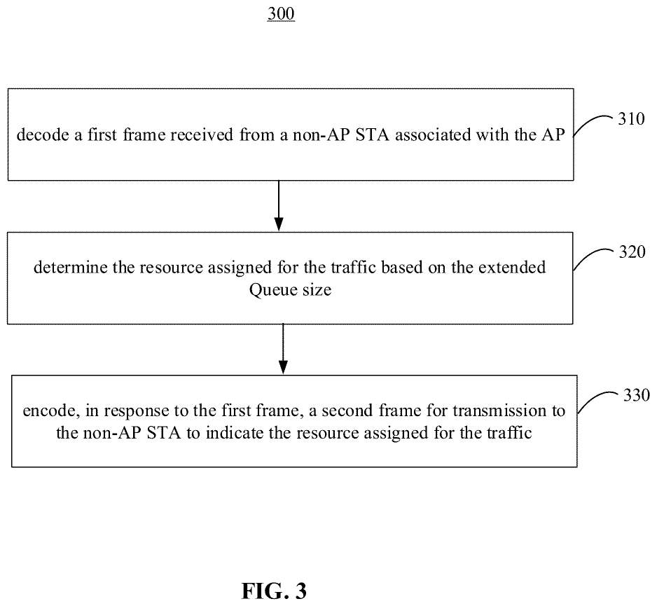

FIG. 2 provides the method for signaling extended BSR from the perspective of the non-AP STA. In comparison, FIG. 3 is a flowchart of a method 300 for signaling extended BSR in accordance with one or more example embodiments of the present disclosure, which is described from the perspective of the AP. The method 300 may be performed by an AP. As shown, the method 300 may include operations 310-330.

At 310, a first frame received from a non-AP STA associated with the AP is decoded. The first frame is to indicate an extended Queue size for a TID to request a resource assigned for a traffic corresponding to the TID. At 320, the resource assigned for the traffic is determined based on the extended Queue size. At 330, in response to the first frame, a second frame is encoded for transmission to the non-AP STA to indicate the resource assigned for the traffic.

In some embodiments, the first frame may include a first field to indicate the TID and an extended UV corresponding to the TID and a second field to indicate the TID and an SF. The AP may determine the extended Queue size for the TID based on the extended UV and the SF.

In some embodiments, the first frame is to indicate the extended Queue size for the TID and the TID within a single field.

In some embodiments, the single field may include a TID subfield to indicate the TID, an extended UV subfield to indicate an extended UV corresponding to the TID, and an SF subfield to indicate an SF. The AP may determine the extended Queue size for the TID based on the extended UV and the SF.

In some embodiments, the single field may include a TID subfield to indicate the TID and an airtime subfield to indicate an airtime corresponding to the TID. The AP may determine the extended Queue size for the TID based on the airtime.

In some embodiments, the single field may include a TID subfield to indicate the TID, a UV subfield to indicate a UV corresponding to the TID, and an SF subfield to indicate a scaled up SF. The AP may determine the extended Queue size for the TID based on the UV and the scaled up SF.

In some embodiments, the single field includes a TID subfield to indicate the TID, a UV subfield to indicate a UV corresponding to the TID, and an SF subfield to indicate an SF. The AP may determine the extended Queue size for the TID based on an unspecified combination of the UV and the SF.

In some embodiments, the first frame includes a first field to indicate an extended UV corresponding to the TID, and a second field to indicate the TID and an SF. The AP may determine the extended Queue size for the TID based on the extended UV and the SF.

In some embodiments, the first frame may include a data frame or a management frame.

In some embodiments, the AP may decode an A-MPDU to obtain a plurality of MPDUs. At least one of the plurality of MPDUs is in the format of the first frame. Then the AP may determine resource assigned for corresponding traffic based on the extended Queue size indicated by the corresponding MPDU.

In the disclosure, in some embodiments, a Queue size may refer to a baseline Queue size in comparison with an extended Queue size. Similarly, a UV may refer to a baseline UV in comparison with an extended UV. Moreover, an SF may refer to a baseline indication in comparison with a scaled up SF which indicates a larger amount. However, in some other embodiments, a Queue size may refer to a baseline Queue size or an extended Queue size, a UV may refer to a baseline UV or an extended UV, or an SF may refers to a baseline indication or a scaled up indication. The disclosure is not limited in this respect.

With the mechanisms for signaling extended BRS, a larger queue size can be reported, so as to improve efficiency of the Wi-Fi system. Furthermore, among the various mechanisms, some mechanisms can be used to indicate multiple TIDs in the same A-MPDU and the AP can identify respective queue size for corresponding TID correctly.

Below, mechanisms about Higher-Priority (HIP) Enhanced Distributed Channel Access (EDCA) will be discussed. The HIP EDCA mechanism is to improve channel access delay on the EDCA mechanism.

In some embodiments, a non-AP STA based on certain conditions may send a special Defer Signal to start EDCA contention for a limited subset of STAs that are eligible for HIP EDCA.

There is a request to provide eligibility criteria and/or enablement of the feature. Ideally UHR STA may use the HIP EDCA procedure for any traffic buffered to a transmission queue of AC_VO or queues of other access categories (e.g. AC_VI, or the like), but AP vendors prefer more control from an AP side to have fine control on the use of the feature.

Some embodiments of the present disclosure relate to systems, methods, and devices for mechanism to enable HIP EDCA though STA to AP negotiation. That is, a control from AP side is considered for the HIP EDCA mechanism. In some embodiments, it is proposed to implement such mechanisms to enable/control the use of HIP EDCA. An optimized negotiation protocol system may define modes of operation.

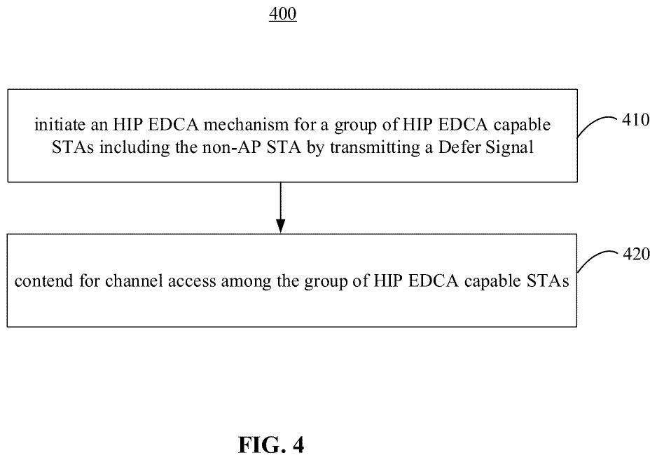

FIG. 4 is a flowchart of a method 400 for HIP EDCA mechanism enhancement in accordance with one or more example embodiments of the present disclosure. The method 400 may be performed by a non-AP STA. As shown, the method 400 may include operations 410-420.

At 410, an HIP EDCA mechanism is initiated for a group of HIP EDCA capable STAs including the non-AP STA by transmitting a Defer Signal. At 420, the non-AP STA contends for channel access among the group of HIP EDCA capable STAs. The initiation of the HIP EDCA mechanism is subject to a constraint of an AP associated with the non-AP STA.

In some embodiments, the initiation of the HIP EDCA mechanism is further subject to a parameter which is predefined or configurable. For example, the STA may use HIP EDCA with conservative parameters (such as frequency of the use, transmission time for DS signal, etc.) in any Basic Service Set (BSS) regardless of the technology of an AP. In another example, the STA may use HIP EDCA with conservative parameters in a certain AP, e.g., UHR AP.

In some embodiments, the non-AP STA may obtain an HIP EDCA parameter advertised by the AP, then initiate the HIP EDCA mechanism following the HIP EDCA parameter.

Additionally or alternatively, in some embodiments, the non-AP STA may directly initiate, when the AP enables an HIP EDCA feature, the HIP EDCA mechanism for a traffic of a first Access Category (AC) if needed. In some embodiments, the non-AP STA may initiate, when the AP enables the HIP EDCA feature, the HIP EDCA mechanism for a traffic of a second AC via a modified Stream Classification Service (SCS) request, wherein the modified SCS request is to request the AP to enable the HIP EDCA feature for the traffic of the second AC.

For example, the STA may use HIP EDCA only if associated to an UHR AP and an UHR AP may advertise HIP EDCA parameters set which STA shall follow. Additionally or alternatively, an AP may enable or disable the use of the feature in a BSS. If enabled, all STAs associated to such AP may use HIP EDCA for traffic buffered into transmission queues of AC_VO for example. If needed, a STA may ask for an extension to use HIP EDCA for AC_VI via modified SCS mechanism. The AC here is an example, such mechanism can be applicable to other ACs, e.g., AC_BE, AC_BK. The disclosure is not limited in this respect.

In some embodiments, the non-AP STA may initiate an SCS mechanism with the AP via an SCS request, and negotiate, when the SCS request is rejected by the AP, with the AP for enablement of an HIP EDCA feature. For example, the STA may use HIP EDCA if associated to an UHR AP only after negotiation with an AP. Such negotiation is done with modified SCS mechanism for the streams that are mapped into a certain traffic, e.g., AC_VO or AC_VI. The AC here is an example, such mechanism can be applicable to other ACs, e.g., AC_BE, AC_BK. The disclosure is not limited in this respect.

Originally, an SCS mechanism is designed to provide information about traffic stream to an AP (such as periodicity, load, delay bounds, burst size). If request accepted, it is expected that an AP will use triggering mechanism to solicit data from that STA. In such a case a STA in exchange for more predictable and controlled service from an AP should not use EDCA and HIP EDCA. An optimized negotiation protocol system may facilitate that if such SCS request for the traffic is rejected, a STA will be able to use HIP EDCA for the traffic buffered into a certain traffic, e.g., AC_VO or AC_VI.

In some embodiments, the non-AP STA may establish an SCS stream between the non-AP STA and the AP for a traffic, and initiate, when the SCS stream is torn down, the HIP EDCA mechanism for the traffic.

In some embodiments, the non-AP STA may initiate the HIP EDCA mechanism via a modified SCS request which is to request the AP to enable the HIP EDCA feature. For example, the STA may send the modified SCS request with a bit indicating that this SCS request is for a traffic stream with unpredictable/undefined characteristics and therefore it will not fit into predictable polling/triggering pattern. With such a request a STA will get permission to use HIP EDCA for that traffic stream. The STA may request maximum number of HIP EDCA opportunities within a given time period during this SCS Request.

In some embodiments, the non-AP STA may encode an SCS request for transmission to the AP. The SCS request may indicate whether to initiate the HIP EDCA mechanism or the SCS mechanism. In some embodiments, the SCS request may include a bit to indicate whether to initiate the HIP EDCA mechanism or an SCS mechanism. For example, the modified SCS request may have a bit to indicate whether the SCS request is to get triggering support from an AP or only to enable HIP EDCA. In some embodiments, the SCS request may include a profile to indicate whether to initiate the HIP EDCA mechanism or an SCS mechanism. For example, such an indication may happen by providing several profiles, one of which may include triggering operations and another one may indicate random access with HIP EDCA support.

In some embodiments, the non-AP STA may initiate an SCS mechanism via an SCS request for a traffic, cause transmission of the traffic via the SCS mechanism when the SCS request is accepted by the AP, and initiate, when a QoS requirement for the traffic is not satisfied, the HIP EDCA mechanism for the pending traffic. For example, after establishing an SCS for the triggered operations, if triggering is not sufficient to satisfy QoS requirement of the traffic stream, the STA may use HIP EDCA to deliver pending traffic. The conditions for which the STA determines that triggering is not sufficient include, but not limited to: instantaneous latency crossing some threshold, the number of triggers arriving within N beacon interval(s) falling below the min requirement etc. These conditions may further be defined in IEEE 802.11 specification (“spec”) or negotiated during SCS setup.

In some embodiments, the non-AP STA is a Multi-Link Device (MLD). The SCS mechanism or the HIP EDCA mechanism may be enabled by the AP at an MLD level. That is the SCS mechanism enablement or the HIP EDCA mechanism enablement happens at an MLD level. Alternatively, it happens at a link level. For example, the AP may signal a specific link(s) of an MLD in which the HIP EDCA is enabled in the SCS Request. For example, it can include the set of link(s) using an ML element within SCS Response frame.

In some embodiments, the non-AP STA is an MLD which may initiate the SCS mechanism or the HIP EDCA mechanism at an MLD level or a link level.

In some embodiments, the SCS mechanism or the HIP EDCA mechanism is initiated based on Access Category (AC) or Traffic Identifier (TID). In an example, the STA MLD may signal in an SCS Request frame whether it wants to enable triggered mode operation for only the TID of the flow signaled in the SCS Request frame; the other TIDs mapped to same AC may use regular EDCA without MU EDCA rules if they are not triggered. If this request is not accepted, the STA may be allowed to use HIP EDCA only for that TID of the AC. In another example, the STA MLD can also request that if the SCS Request is accepted for a given TID for triggered only mode, then the other TIDs for that AC may be allowed to use HIP EDCA.

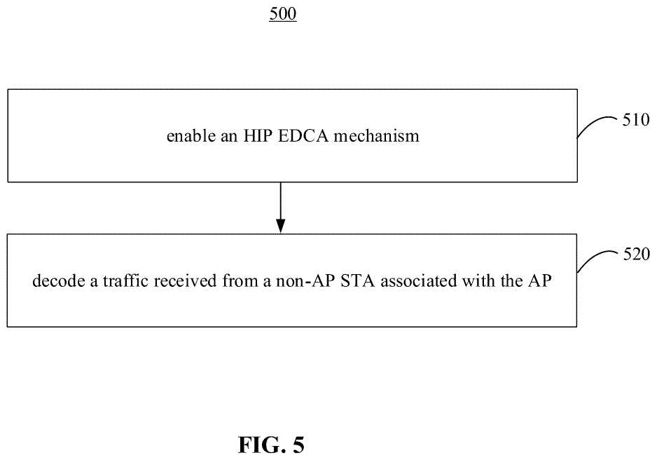

FIG. 5 is a flowchart of a method 500 for HIP EDCA mechanism enhancement in accordance with one or more example embodiments of the present disclosure. Compared with FIG. 4 which is performed by the non-AP STA, FIG. 5 may be performed by the AP. The method 500 may include operations 510 and 520.

At 510, the AP enables an HIP EDCA mechanism. At 520, the AP decodes a traffic received from a non-AP STA associated with the AP. The traffic is transmitted by the non-AP STA via the HIP EDCA mechanism.

In some embodiments, the AP may advertise an HIP EDCA parameter to allow the non-AP STA to perform the HIP EDCA mechanism following the HIP EDCA parameter.

In some embodiments, the AP may decode an SCS request received from the non-AP STA, and negotiate, when the SCS request is rejected by the AP, with the non-AP STA for enablement of an HIP EDCA feature.

In some embodiments, the AP may decode an SCS request for a traffic received from the non-AP STA, decode a traffic based on resource provided for the traffic after accepting the SCS request, and allow, when a QoS requirement for the traffic is not satisfied, the HIP EDCA mechanism for the pending traffic.

In some embodiments, the AP may decode a modified SCS request received from the non-AP STA. The modified SCS request may be used to request the AP to enable the HIP EDCA feature.

In some embodiments, the AP may decode an SCS request received from the non-AP STA. The SCS request may indicate whether to initiate the HIP EDCA mechanism or an SCS mechanism. For example, the SCS request includes a bit to indicate whether to initiate the HIP EDCA mechanism or an SCS mechanism. In another example, the SCS request includes a profile to indicate whether to initiate the HIP EDCA mechanism or an SCS mechanism.

In some embodiments, the AP may establish an SCS stream between the non-AP STA and the AP for a traffic, and allow, when the SCS stream is torn down, the HIP EDCA mechanism for the traffic.

In some embodiments where the non-AP STA is an MLD, the AP may enable the SCS mechanism or the HIP EDCA mechanism at an MLD level or a link level.

In some embodiments, the AP may enable the SCS mechanism or the HIP EDCA mechanism based on AC or TID. That is, all the mechanisms discussed herein can be performed based on AC or TID. The AC may include, for example, AC_VO, AC_VI, AC_BE, AC_BK, an so on.

Embodiments about method 500 can be understood in conjunction with those described with respect to method 400, which will not be repeated here.

With the solutions above, the HIP EDCA mechanism or the modified SCS mechanism can be enhanced with the control of the AP, so that the performance of the system can be improved.

FIG. 6 shows a functional diagram of an exemplary communication station 600, in accordance with one or more example embodiments of the present disclosure. In one embodiment, FIG. 6 illustrates a functional block diagram of a communication station that may be suitable for use as an AP 102 (FIG. 1) or a user device 120 (FIG. 1) or a user device 220 (FIG. 2) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer (PHY) communications and/or medium access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in the above figures, diagrams, and flows.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a mechanism enhancement unit 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB)), parallel, or other wired or wireless (e.g., infrared (IR), near field communication (NFC), etc.) connection to communicate with or control one or more peripheral devices (e.g., a printer, a card reader, etc.). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 702 for generation and processing of the baseband signals and for controlling operations of the main memory 704, the storage device 716, and/or the mechanism enhancement unit 719. The baseband processor may be provided on a single radio card, a single chip, or an integrated circuit (IC).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The mechanism enhancement unit 719 may carry out or perform any of the operations and processes described and shown above.

It is understood that the above are only a subset of what the mechanism enhancement unit 719 may be configured to perform and that other functions included throughout this disclosure may also be performed by the mechanism enhancement unit 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software.

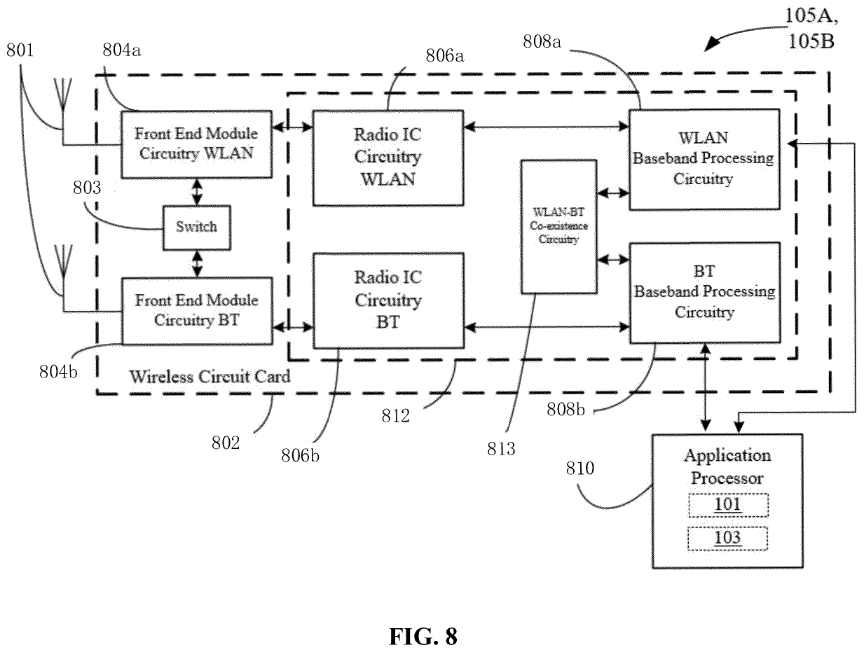

FIG. 8 is a block diagram of a radio architecture 105A, 105B in accordance with some embodiments that may be implemented in any one of the example APs 102 and/or the example STAs 120 of FIG. 1 and/or a user device 220 (FIG. 2). Radio architecture 105A, 105B may include radio front-end module (FEM) circuitry 804a-b, radio IC circuitry 806a-b and baseband processing circuitry 808a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 804a-b may include a WLAN or Wi-Fi FEM circuitry 804a and a Bluetooth (BT) FEM circuitry 804b. The WLAN FEM circuitry 804a may include a receive signal path comprising circuitry configured to operate on WLAN RF signals received from one or more antennas 801, to amplify the received signals and to provide the amplified versions of the received signals to the WLAN radio IC circuitry 806a for further processing. The BT FEM circuitry 804b may include a receive signal path which may include circuitry configured to operate on BT RF signals received from one or more antennas 801, to amplify the received signals and to provide the amplified versions of the received signals to the BT radio IC circuitry 806b for further processing. FEM circuitry 804a may also include a transmit signal path which may include circuitry configured to amplify WLAN signals provided by the radio IC circuitry 806a for wireless transmission by one or more of the antennas 801. In addition, FEM circuitry 804b may also include a transmit signal path which may include circuitry configured to amplify BT signals provided by the radio IC circuitry 806b for wireless transmission by the one or more antennas. In the embodiment of FIG. 8, although FEM 804a and FEM 804b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 806a-b as shown may include WLAN radio IC circuitry 806a and BT radio IC circuitry 806b. The WLAN radio IC circuitry 806a may include a receive signal path which may include circuitry to down-convert WLAN RF signals received from the FEM circuitry 804a and provide baseband signals to WLAN baseband processing circuitry 808a. BT radio IC circuitry 806b may in turn include a receive signal path which may include circuitry to down-convert BT RF signals received from the FEM circuitry 804b and provide baseband signals to BT baseband processing circuitry 808b. WLAN radio IC circuitry 806a may also include a transmit signal path which may include circuitry to up-convert WLAN baseband signals provided by the WLAN baseband processing circuitry 808a and provide WLAN RF output signals to the FEM circuitry 804a for subsequent wireless transmission by the one or more antennas 801. BT radio IC circuitry 806b may also include a transmit signal path which may include circuitry to up-convert BT baseband signals provided by the BT baseband processing circuitry 808b and provide BT RF output signals to the FEM circuitry 804b for subsequent wireless transmission by the one or more antennas 801. In the embodiment of FIG. 8, although radio IC circuitries 806a and 806b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 808a-b may include a WLAN baseband processing circuitry 808a and a BT baseband processing circuitry 808b. The WLAN baseband processing circuitry 808a may include a memory, such as, for example, a set of RAM arrays in a Fast Fourier Transform or Inverse Fast Fourier Transform block (not shown) of the WLAN baseband processing circuitry 808a. Each of the WLAN baseband circuitry 808a and the BT baseband circuitry 808b may further include one or more processors and control logic. Each of the WLAN baseband circuitry 808a and the BT baseband circuitry 808b may further include an interface circuitry coupled with corresponding one or more processors and control logic. The one or more processors and control logic may process the signals received, via the interface circuitry, from the corresponding WLAN or BT receive signal path of the radio IC circuitry 806a-b, and to also generate corresponding WLAN or BT baseband signals for the transmit signal path of the radio IC circuitry 806a-b. Each of the baseband processing circuitries 808a and 808b may further include physical layer (PHY) and medium access control layer (MAC) circuitry, and may further interface with a device for generation and processing of the baseband signals and for controlling operations of the radio IC circuitry 806a-b.

Referring still to FIG. 8, according to the shown embodiment, WLAN-BT coexistence circuitry 813 may include logic providing an interface between the WLAN baseband circuitry 808a and the BT baseband circuitry 808b to enable use cases requiring WLAN and BT coexistence. In addition, a switch 803 may be provided between the WLAN FEM circuitry 804a and the BT FEM circuitry 804b to allow switching between the WLAN and BT radios according to application needs. In addition, although the antennas 801 are depicted as being respectively connected to the WLAN FEM circuitry 804a and the BT FEM circuitry 804b, embodiments include within their scope the sharing of one or more antennas as between the WLAN and BT FEMs, or the provision of more than one antenna connected to each of FEM 804a or 804b.

In some embodiments, the front-end module circuitry 804a-b, the radio IC circuitry 806a-b, and baseband processing circuitry 808a-b may be provided on a single radio card, such as wireless radio card 802. In some other embodiments, the one or more antennas 801, the FEM circuitry 804a-b and the radio IC circuitry 806a-b may be provided on a single radio card. In some other embodiments, the radio IC circuitry 806a-b and the baseband processing circuitry 808a-b may be provided on a single chip or integrated circuit (IC), such as IC 812.

In some embodiments, the wireless radio card 802 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 808b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

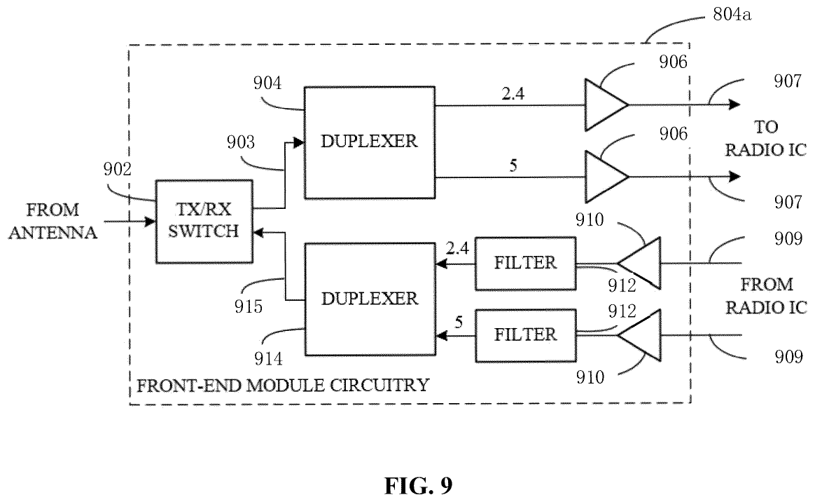

FIG. 9 illustrates WLAN FEM circuitry 804a in accordance with some embodiments. Although the example of FIG. 9 is described in conjunction with the WLAN FEM circuitry 804a, the example of FIG. 9 may be described in conjunction with the example BT FEM circuitry 804b (FIG. 8), although other circuitry configurations may also be suitable.

In some embodiments, the FEM circuitry 804a may include a TX/RX switch 902 to switch between transmit mode and receive mode operation. The FEM circuitry 804a may include a receive signal path and a transmit signal path. The receive signal path of the FEM circuitry 804a may include a low-noise amplifier (LNA) 906 to amplify received RF signals 903 and provide the amplified received RF signals 907 as an output (e.g., to the radio IC circuitry 806a-b (FIG. 8)). The transmit signal path of the circuitry 804a may include a power amplifier (PA) to amplify input RF signals 909 (e.g., provided by the radio IC circuitry 806a-b), and one or more filters 912, such as band-pass filters (BPFs), low-pass filters (LPFs) or other types of filters, to generate RF signals 915 for subsequent transmission (e.g., by one or more of the antennas 801 (FIG. 8)) via an example duplexer 914.

In some dual-mode embodiments for Wi-Fi communication, the FEM circuitry 804a may be configured to operate in either the 2.4 GHz frequency spectrum or the 5 GHz frequency spectrum. In these embodiments, the receive signal path of the FEM circuitry 804a may include a receive signal path duplexer 904 to separate the signals from each spectrum as well as provide a separate LNA 906 for each spectrum as shown. In these embodiments, the transmit signal path of the FEM circuitry 804a may also include a power amplifier 910 and a filter 912, such as a BPF, an LPF or another type of filter for each frequency spectrum and a transmit signal path duplexer 904 to provide the signals of one of the different spectrums onto a single transmit path for subsequent transmission by the one or more of the antennas 801 (FIG. 8). In some embodiments, BT communications may utilize the 2.4 GHz signal paths and may utilize the same FEM circuitry 804a as the one used for WLAN communications.

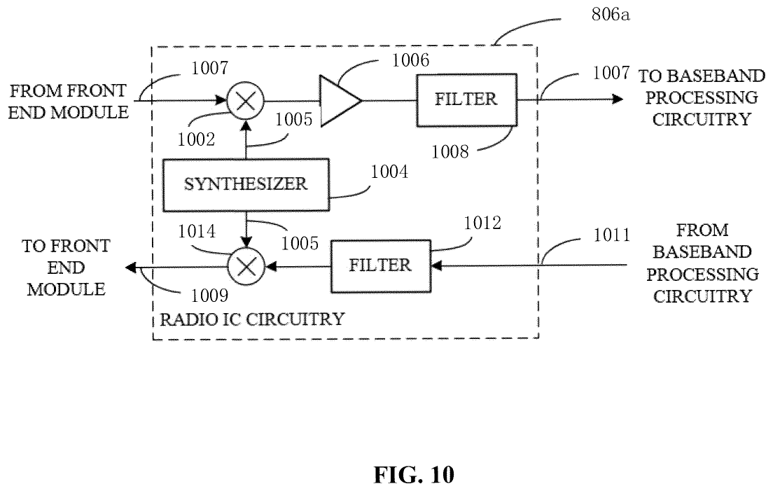

FIG. 10 illustrates radio IC circuitry 806a in accordance with some embodiments. The radio IC circuitry 806a is one example of circuitry that may be suitable for use as the WLAN or BT radio IC circuitry 806a/806b (FIG. 8), although other circuitry configurations may also be suitable. Alternatively, the example of FIG. 10 may be described in conjunction with the example BT radio IC circuitry 806b.

In some embodiments, the radio IC circuitry 806a may include a receive signal path and a transmit signal path. The receive signal path of the radio IC circuitry 806a may include at least mixer circuitry 1002, such as, for example, down-conversion mixer circuitry, amplifier circuitry 1006 and filter circuitry 1008. The transmit signal path of the radio IC circuitry 806a may include at least filter circuitry 1012 and mixer circuitry 1014, such as, for example, up-conversion mixer circuitry. Radio IC circuitry 806a may also include synthesizer circuitry 1004 for synthesizing a frequency 1005 for use by the mixer circuitry 1002 and the mixer circuitry 1014. The mixer circuitry 1002 and/or 1014 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 10 illustrates only a simplified version of a radio IC circuitry, and may include, although not shown, embodiments where each of the depicted circuitries may include more than one component. For instance, mixer circuitry 1014 may each include one or more mixers, and filter circuitries 1008 and/or 1012 may each include one or more filters, such as one or more BPFs and/or LPFs according to application needs. For example, when mixer circuitries are of the direct-conversion type, they may each include two or more mixers.

In some embodiments, mixer circuitry 1002 may be configured to down-convert RF signals 907 received from the FEM circuitry 804a-b (FIG. 8) based on the synthesized frequency 1005 provided by synthesizer circuitry 1004. The amplifier circuitry 1006 may be configured to amplify the down-converted signals and the filter circuitry 1008 may include an LPF configured to remove unwanted signals from the down-converted signals to generate output baseband signals 1007. Output baseband signals 1007 may be provided to the baseband processing circuitry 808a-b (FIG. 8) for further processing. In some embodiments, the output baseband signals 1007 may be zero-frequency baseband signals, although this is not a requirement. In some embodiments, mixer circuitry 1002 may comprise passive mixers, although the scope of the embodiments is not limited in this respect.

In some embodiments, the mixer circuitry 1014 may be configured to up-convert input baseband signals 1011 based on the synthesized frequency 1005 provided by the synthesizer circuitry 1004 to generate RF output signals 909 for the FEM circuitry 804a-b. The baseband signals 1011 may be provided by the baseband processing circuitry 808a-b and may be filtered by filter circuitry 1012. The filter circuitry 1012 may include an LPF or a BPF, although the scope of the embodiments is not limited in this respect.

In some embodiments, the mixer circuitry 1002 and the mixer circuitry 1014 may each include two or more mixers and may be arranged for quadrature down-conversion and/or up-conversion respectively with the help of synthesizer 1004. In some embodiments, the mixer circuitry 1002 and the mixer circuitry 1014 may each include two or more mixers each configured for image rejection (e.g., Hartley image rejection). In some embodiments, the mixer circuitry 1002 and the mixer circuitry 1014 may be arranged for direct down-conversion and/or direct up-conversion, respectively. In some embodiments, the mixer circuitry 1002 and the mixer circuitry 1014 may be configured for super-heterodyne operation, although this is not a requirement.

Mixer circuitry 1002 may comprise, according to one embodiment: quadrature passive mixers (e.g., for the in-phase (I) and quadrature phase (Q) paths). In such an embodiment, RF input signal 907 from FIG. 10 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1005 of synthesizer 1004 (FIG. 10). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 907 (FIG. 9) may comprise a balanced signal, although the scope of the embodiments is not limited in this respect. The I and Q baseband output signals may be provided to low-noise amplifier, such as amplifier circuitry 1006 (FIG. 10) or to filter circuitry 1008 (FIG. 10).

In some embodiments, the output baseband signals 1007 and the input baseband signals 1011 may be analog baseband signals, although the scope of the embodiments is not limited in this respect. In some alternate embodiments, the output baseband signals 1007 and the input baseband signals 1011 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1004 may be a fractional-N synthesizer or a fractional N/N+1 synthesizer, although the scope of the embodiments is not limited in this respect as other types of frequency synthesizers may be suitable. For example, synthesizer circuitry 1004 may be a delta-sigma synthesizer, a frequency multiplier, or a synthesizer comprising a phase-locked loop with a frequency divider. According to some embodiments, the synthesizer circuitry 1004 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1004 may be provided by a voltage controlled oscillator (VCO), although that is not a requirement. A divider control input may further be provided by either the baseband processing circuitry 808a-b (FIG. 8) depending on the desired output frequency 1005. In some embodiments, a divider control input (e.g., N) may be determined from a look-up table (e.g., within a Wi-Fi card) based on a channel number and a channel center frequency as determined or indicated by the example application processor 810. The application processor 810 may include, or otherwise be connected to, one of the example secure signal converter 101 or the example received signal converter 103 (e.g., depending on which device the example radio architecture is implemented in).

In some embodiments, synthesizer circuitry 1004 may be configured to generate a carrier frequency as the output frequency 1005, while in other embodiments, the output frequency 1005 may be a fraction of the carrier frequency (e.g., one-half the carrier frequency, one-third the carrier frequency). In some embodiments, the output frequency 1005 may be a LO frequency (fLO).

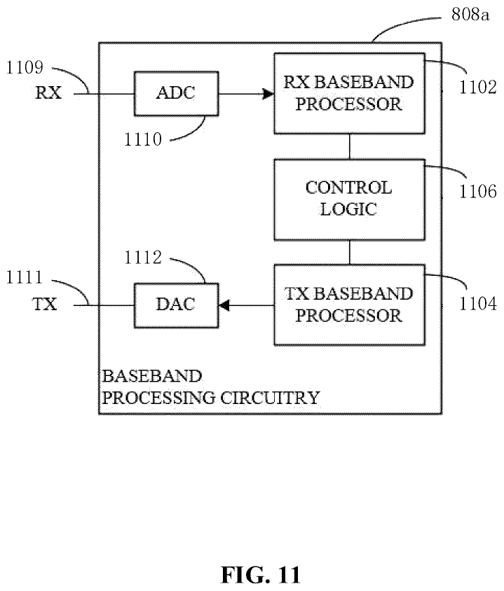

FIG. 11 illustrates a functional block diagram of baseband processing circuitry 808a in accordance with some embodiments. The baseband processing circuitry 808a is one example of circuitry that may be suitable for use as the baseband processing circuitry 808a (FIG. 8), although other circuitry configurations may also be suitable. Alternatively, the example of FIG. 10 may be used to implement the example BT baseband processing circuitry 808b of FIG. 8.

The baseband processing circuitry 808a may include a receive baseband processor (RX BBP) 1102 for processing receive baseband signals 1009 provided by the radio IC circuitry 806a-b (FIG. 8) and a transmit baseband processor (TX BBP) 1104 for generating transmit baseband signals 1011 for the radio IC circuitry 806a-b. The baseband processing circuitry 808a may also include control logic 1106 for coordinating the operations of the baseband processing circuitry 808a.

In some embodiments (e.g., when analog baseband signals are exchanged between the baseband processing circuitry 808a-b and the radio IC circuitry 806a-b), the baseband processing circuitry 808a may include ADC 1110 to convert analog baseband signals 1109 received from the radio IC circuitry 806a-b to digital baseband signals for processing by the RX BBP 1102. In these embodiments, the baseband processing circuitry 808a may also include DAC 1112 to convert digital baseband signals from the TX BBP 1104 to analog baseband signals 1111.

In some embodiments that communicate OFDM signals or OFDMA signals, such as through baseband processor 808a, the transmit baseband processor 1104 may be configured to generate OFDM or OFDMA signals as appropriate for transmission by performing an inverse fast Fourier transform (IFFT). The receive baseband processor 1102 may be configured to process received OFDM signals or OFDMA signals by performing an FFT. In some embodiments, the receive baseband processor 1102 may be configured to detect the presence of an OFDM signal or OFDMA signal by perf orming an autocorrelation, to detect a preamble, such as a short preamble, and by performing a cross-correlation, to detect a long preamble. The preambles may be part of a predetermined frame structure for Wi-Fi communication.

Referring back to FIG. 8, in some embodiments, the antennas 801 (FIG. 8) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 801 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following paragraphs describe examples of various embodiments.

Example A1 include an apparatus for a non Access Point (non-AP) Station (STA), comprising: interface circuitry; and processor circuitry coupled with the interface circuitry, wherein the processor circuitry is to: encode a first frame for transmission to an AP associated with the non-AP STA via the interface circuitry, wherein the first frame is to indicate an extended Queue size for a Traffic Identifier (TID) to request a resource assigned for a traffic corresponding to the TID; decode a second frame received from the AP via the interface circuitry in response to the first frame to obtain the resource assigned for the traffic; and cause transmission of the traffic to the AP with the assigned resource.

Example A2 includes the apparatus of Example A1 or any other Examples herein, wherein the first frame includes a first field to indicate the TID and an extended Unscaled Value (UV) corresponding to the TID and a second field to indicate the TID and a Scaling Factor (SF), and wherein the extended Queue size for the TID is based on the extended UV and the SF.

Example A3 includes the apparatus of Example A1 or any other Examples herein, wherein the first frame is to indicate the extended Queue size for the TID and the TID within a single field.

Example A4 includes the apparatus of Example A3 or any other Examples herein, wherein the single field includes a TID subfield to indicate the TID, an extended Unscaled Value (UV) subfield to indicate an extended UV corresponding to the TID, and a Scaling Factor (SF) subfield to indicate an SF, and wherein the extended Queue size for the TID is based on the extended UV and the SF.

Example A5 includes the apparatus of Example A3 or any other Examples herein, wherein the single field includes a TID subfield to indicate the TID and an airtime subfield to indicate an airtime corresponding to the TID, and wherein the extended Queue size for the TID is based on the airtime.

Example A6 includes the apparatus of Example A3 or any other Examples herein, wherein the single field includes a TID subfield to indicate the TID, an Unscaled Value (UV) subfield to indicate a UV corresponding to the TID, and a Scaling Factor (SF) subfield to indicate a scaled up SF, and wherein the extended Queue size for the TID is based on the UV and the scaled up SF.

Example A7 includes the apparatus of Example A3 or any other Examples herein, wherein the single field includes a TID subfield to indicate the TID, an Unscaled Value (UV) subfield to indicate a UV corresponding to the TID, and a Scaling Factor (SF) subfield to indicate an SF, and wherein the extended Queue size for the TID is based on an unspecified combination of the UV and the SF.

Example A8 includes the apparatus of Example A1 or any other Examples herein, wherein the first frame includes a first field to indicate an extended Unscaled Value (UV) corresponding to the TID, and a second field to indicate the TID and a Scaling Factor (SF), and wherein the extended Queue size for the TID is based on the extended UV and the SF.

Example A9 includes the apparatus of any of Examples A1 to A8 or any other Examples herein, wherein the first frame includes a data frame or a management frame.

Example A10 includes the apparatus of any of Examples A1 to A8 or any other Examples herein, wherein the processor circuitry is further to: aggregate a plurality of Media Access Control (MAC) Protocol Data Units (MPDUs) to obtain an Aggregated MPDU (A-MPDU), wherein at least one of the plurality of MPDUs is in the format of the first frame; and cause transmission of the A-MPDU to the AP via the interface circuitry.

Example A11 includes an apparatus for an Access Point (AP), comprising: interface circuitry; and processor circuitry coupled with the interface circuitry, wherein the processor circuitry is to: decode a first frame received from a non-AP Station (STA) associated with the AP via the interface circuitry, wherein the first frame is to indicate an extended Queue size for a Traffic Identifier (TID) to request a resource assigned for a traffic corresponding to the TID; determine the resource assigned for the traffic based on the extended Queue size; and encode, in response to the first frame, a second frame for transmission to the non-AP STA via the interface circuitry to indicate the resource assigned for the traffic.

Example A12 includes the apparatus of Example A11 or any other Examples herein, wherein the first frame includes a first field to indicate the TID and an extended Unscaled Value (UV) corresponding to the TID and a second field to indicate the TID and a Scaling Factor (SF), and wherein the processor circuitry is further to: determine the extended Queue size for the TID based on the extended UV and the SF.

Example A13 includes the apparatus of Example A11 or any other Examples herein, wherein the first frame is to indicate the extended Queue size for the TID and the TID within a single field.

Example A14 includes the apparatus of Example A13 or any other Examples herein, wherein the single field includes a TID subfield to indicate the TID, an extended Unscaled Value (UV) subfield to indicate an extended UV corresponding to the TID, and a Scaling Factor (SF) subfield to indicate an SF, and wherein the processor circuitry is further to: determine the extended Queue size for the TID based on the extended UV and the SF.

Example A15 includes the apparatus of Example A13 or any other Examples herein, wherein the single field includes a TID subfield to indicate the TID and an airtime subfield to indicate an airtime corresponding to the TID, and wherein the processor circuitry is further to: determine the extended Queue size for the TID based on the airtime.

Example A16 includes the apparatus of Example A13 or any other Examples herein, wherein the single field includes a TID subfield to indicate the TID, an Unscaled Value (UV) subfield to indicate a UV corresponding to the TID, and a Scaling Factor (SF) subfield to indicate a scaled up SF, and wherein the processor circuitry is further to: determine the extended Queue size for the TID based on the UV and the scaled up SF.

Example A17 includes the apparatus of Example A13 or any other Examples herein, wherein the single field includes a TID subfield to indicate the TID, an Unscaled Value (UV) subfield to indicate a UV corresponding to the TID, and a Scaling Factor (SF) subfield to indicate an SF, and wherein the processor circuitry is further to: determine the extended Queue size for the TID based on an unspecified combination of the UV and the SF.

Example A18 includes the apparatus of Example A11 or any other Examples herein, wherein the first frame includes a first field to indicate an extended Unscaled Value (UV) corresponding to the TID, and a second field to indicate the TID and a Scaling Factor (SF), and wherein the processor circuitry is further to: determine the extended Queue size for the TID based on the extended UV and the SF.

Example A19 includes the apparatus of any of Examples A11 to A18 or any other Examples herein, wherein the first frame includes a data frame or a management frame.

Example A20 includes the apparatus of any of Examples A11 to A18 or any other Examples herein, wherein the processor circuitry is further to: decode an Aggregated Media Access Control (MAC) Protocol Data Units (MPDU) (A-MPDU) to obtain a plurality of MPDUs, wherein at least one of the plurality of MPDUs is in the format of the first frame; and determine resource assigned for corresponding traffic based on the extended Queue size indicated by the corresponding MPDU.

Example A21 includes a method for a non Access Point (non-AP) Station (STA), comprising: encoding a first frame for transmission to an AP associated with the non-AP STA, wherein the first frame is to indicate an extended Queue size for a Traffic Identifier (TID) to request a resource assigned for a traffic corresponding to the TID; decoding a second frame received from the AP in response to the first frame to obtain the resource assigned for the traffic; and causing transmission of the traffic to the AP with the assigned resource.

Example A22 includes the method of Example A21 or any other Examples herein, wherein the first frame includes a first field to indicate the TID and an extended Unscaled Value (UV) corresponding to the TID and a second field to indicate the TID and a Scaling Factor (SF), and wherein the extended Queue size for the TID is based on the extended UV and the SF.

Example A23 includes the method of Example A21 or any other Examples herein, wherein the first frame is to indicate the extended Queue size for the TID and the TID within a single field.

Example A24 includes the method of Example A23 or any other Examples herein, wherein the single field includes a TID subfield to indicate the TID, an extended Unscaled Value (UV) subfield to indicate an extended UV corresponding to the TID, and a Scaling Factor (SF) subfield to indicate an SF, and wherein the extended Queue size for the TID is based on the extended UV and the SF.

Example A25 includes the method of Example A23 or any other Examples herein, wherein the single field includes a TID subfield to indicate the TID and an airtime subfield to indicate an airtime corresponding to the TID, and wherein the extended Queue size for the TID is based on the airtime.

Example A26 includes the method of Example A23 or any other Examples herein, wherein the single field includes a TID subfield to indicate the TID, an Unscaled Value (UV) subfield to indicate a UV corresponding to the TID, and a Scaling Factor (SF) subfield to indicate a scaled up SF, and wherein the extended Queue size for the TID is based on the UV and the scaled up SF.

Example A27 includes the method of Example A23 or any other Examples herein, wherein the single field includes a TID subfield to indicate the TID, an Unscaled Value (UV) subfield to indicate a UV corresponding to the TID, and a Scaling Factor (SF) subfield to indicate an SF, and wherein the extended Queue size for the TID is based on an unspecified combination of the UV and the SF.

Example A28 includes the method of Example A21 or any other Examples herein, wherein the first frame includes a first field to indicate an extended Unscaled Value (UV) corresponding to the TID, and a second field to indicate the TID and a Scaling Factor (SF), and wherein the extended Queue size for the TID is based on the extended UV and the SF.

Example A29 includes the method of any of Examples A21 to A28 or any other Examples herein, wherein the first frame includes a data frame or a management frame.

Example A30 includes the method of any of Examples A21 to A28 or any other Examples herein, further comprising: aggregating a plurality of Media Access Control (MAC) Protocol Data Units (MPDUs) to obtain an Aggregated MPDU (A-MPDU), wherein at least one of the plurality of MPDUs is in the format of the first frame; and causing transmission of the A-MPDU to the AP.

Example A31 includes a method for an Access Point (AP), comprising: decoding a first frame received from a non-AP Station (STA) associated with the AP, wherein the first frame is to indicate an extended Queue size for a Traffic Identifier (TID) to request a resource assigned for a traffic corresponding to the TID; determining the resource assigned for the traffic based on the extended Queue size; and encoding, in response to the first frame, a second frame for transmission to the non-AP STA to indicate the resource assigned for the traffic.

Example A32 includes the method of Example A31 or any other Examples herein, wherein the first frame includes a first field to indicate the TID and an extended Unscaled Value (UV) corresponding to the TID and a second field to indicate the TID and a Scaling Factor (SF), and wherein the method further comprises: determining the extended Queue size for the TID based on the extended UV and the SF.

Example A33 includes the method of Example A31 or any other Examples herein, wherein the first frame is to indicate the extended Queue size for the TID and the TID within a single field.

Example A34 includes the method of Example A33 or any other Examples herein, wherein the single field includes a TID subfield to indicate the TID, an extended Unscaled Value (UV) subfield to indicate an extended UV corresponding to the TID, and a Scaling Factor (SF) subfield to indicate an SF, and wherein the method further comprises: determining the extended Queue size for the TID based on the extended UV and the SF.

Example A35 includes the method of Example A33 or any other Examples herein, wherein the single field includes a TID subfield to indicate the TID and an airtime subfield to indicate an airtime corresponding to the TID, and wherein the method further comprises: determining the extended Queue size for the TID based on the airtime.

Example A36 includes the method of Example A33 or any other Examples herein, wherein the single field includes a TID subfield to indicate the TID, an Unscaled Value (UV) subfield to indicate a UV corresponding to the TID, and a Scaling Factor (SF) subfield to indicate a scaled up SF, and wherein the method further comprises: determining the extended Queue size for the TID based on the UV and the scaled up SF.

Example A37 includes the method of Example A33 or any other Examples herein, wherein the single field includes a TID subfield to indicate the TID, an Unscaled Value (UV) subfield to indicate a UV corresponding to the TID, and a Scaling Factor (SF) subfield to indicate an SF, and wherein the method further comprises: determining the extended Queue size for the TID based on an unspecified combination of the UV and the SF.

Example A38 includes the method of Example A31 or any other Examples herein, wherein the first frame includes a first field to indicate an extended Unscaled Value (UV) corresponding to the TID, and a second field to indicate the TID and a Scaling Factor (SF), and wherein the method further comprises: determining the extended Queue size for the TID based on the extended UV and the SF.

Example A39 includes the method of any of Examples A31 to A38 or any other Examples herein, wherein the first frame includes a data frame or a management frame.

Example A40 includes the method of any of Examples A31 to A38 or any other Examples herein, further comprising: decoding an Aggregated Media Access Control (MAC) Protocol Data Units (MPDU) (A-MPDU) to obtain a plurality of MPDUs, wherein at least one of the plurality of MPDUs is in the format of the first frame; and determining resource assigned for corresponding traffic based on the extended Queue size indicated by the corresponding MPDU.

Example A41 includes a computer-readable medium having instructions stored thereon, wherein the instructions, when executed by processing circuitry, cause the processing circuitry to perform the method of any of Examples A21-A30 or any other Examples herein.

Example A42. A computer-readable medium having instructions stored thereon, wherein the instructions, when executed by processing circuitry, cause the processing circuitry to perform the method of any of Examples A31-A40 or any other Examples herein.

Example B1 includes an apparatus for a non Access Point (non-AP) Station (STA), comprising: interface circuitry; and processor circuitry coupled with the interface circuitry, wherein the processor circuitry is to: initiate a Higher-Priority (HIP) Enhanced Distributed Channel Access (EDCA) mechanism for a group of HIP EDCA capable STAs including the non-AP STA by transmitting a Defer Signal via the interface circuitry; and contend for channel access among the group of HIP EDCA capable STAs, wherein the initiation of the HIP EDCA mechanism is subject to a constraint of an AP associated with the non-AP STA.

Example B2 includes the apparatus of Example B1 or any other Examples herein, wherein the processor circuitry is further to: obtain an HIP EDCA parameter advertised by the AP; and initiate the HIP EDCA mechanism following the HIP EDCA parameter.

Example B3 includes the apparatus of Example B1 or any other Examples herein, wherein the processor circuitry is further to: directly initiate, when the AP enables an HIP EDCA feature, the HIP EDCA mechanism for a traffic of a first Access Category (AC) if needed; or initiate, when the AP enables the HIP EDCA feature, the HIP EDCA mechanism for a traffic of a second AC via a modified Stream Classification Service (SCS) request, wherein the modified SCS request is to request the AP to enable the HIP EDCA feature for the traffic of the second AC.

Example B4 includes the apparatus of Example B1 or any other Examples herein, wherein the processor circuitry is further to: initiate a Stream Classification Service (SCS) mechanism with the AP via an SCS request; negotiate, when the SCS request is rejected by the AP, with the AP for enablement of an HIP EDCA feature.

Example B5 includes the apparatus of Example B1 or any other Examples herein, wherein the processor circuitry is further to: initiate a Stream Classification Service (SCS) mechanism via an SCS request for a traffic; cause transmission of the traffic via the SCS mechanism when the SCS request is accepted by the AP; initiate, when a Quality of Service (QoS) requirement for the traffic is not satisfied, the HIP EDCA mechanism for the pending traffic.

Example B6 includes the apparatus of Example B1 or any other Examples herein, wherein the processor circuitry is further to: initiate the HIP EDCA mechanism via a modified Stream Classification Service (SCS) request, wherein the modified SCS request is to request the AP to enable the HIP EDCA feature.

Example B7 includes the apparatus of Example B1 or any other Examples herein, wherein the processor circuitry is further to: encode a Stream Classification Service (SCS) request for transmission to the AP via the interface circuitry, wherein the SCS request is to indicate whether to initiate the HIP EDCA mechanism or an SCS mechanism.

Example B8 includes the apparatus of Example B7 or any other Examples herein, wherein the SCS request includes a bit to indicate whether to initiate the HIP EDCA mechanism or an SCS mechanism; or the SCS request includes a profile to indicate whether to initiate the HIP EDCA mechanism or an SCS mechanism.

Example B9 includes the apparatus of Example B1 or any other Examples herein, wherein the processor circuitry is further to: establish a Stream Classification Service (SCS) stream between the non-AP STA and the AP for a traffic; and initiate, when the SCS stream is torn down, the HIP EDCA mechanism for the traffic.

Example B10 includes the apparatus of any of Examples B3 to B9 or any other Examples herein, wherein the non-AP STA is a Multi-Link Device (MLD), and wherein the SCS mechanism is enabled at an MLD level or a link level.

Example B11 includes the apparatus of any of Examples B3 to B9 or any other Examples herein, wherein the non-AP STA is a Multi-Link Device (MLD), and wherein the processor circuitry is further to: initiate the SCS mechanism at an MLD level or a link level.

Example B12 includes the apparatus of any of Examples B3 to B9 or any other Examples herein, wherein the SCS mechanism is initiated based on Access Category (AC) or Traffic Identifier (TID).

Example B13 includes the apparatus of Example B1 or any other Examples herein, wherein the initiation of the HIP EDCA mechanism is further subject to a constraint parameter which is predefined or configurable.

Example B14 includes the apparatus of Example B1 or any other Examples herein, wherein the non-AP STA is a Multi-Link Device (MLD), and wherein the HIP EDCA mechanism is enabled at an MLD level or a link level.

Example B15 includes the apparatus of Example B1 or any other Examples herein, wherein the non-AP STA is a Multi-Link Device (MLD), and wherein the processor circuitry is further to: initiate the HIP EDCA mechanism at an MLD level or a link level.

Example B16 includes the apparatus of Example B1 or any other Examples herein, wherein the HIP EDCA mechanism is initiated based on Access Category (AC) or Traffic Identifier (TID).

Example B17 includes an apparatus for an Access Point (AP), comprising: interface circuitry; and processor circuitry coupled with the interface circuitry, wherein the processor circuitry is to: enable a Higher-Priority (HIP) Enhanced Distributed Channel Access (EDCA) mechanism; decode a traffic received from a non-AP Station (STA) associated with the AP via the interface circuitry, wherein the traffic is transmitted by the non-AP STA via the HIP EDCA mechanism.

Example B18 includes the apparatus of Example B17 or any other Examples herein, wherein the processor circuitry is further to: advertise an HIP EDCA parameter to allow the non-AP STA to perform the HIP EDCA mechanism following the HIP EDCA parameter.

Example B19 includes the apparatus of Example B17 or any other Examples herein, wherein the processor circuitry is further to: decode a Stream Classification Service (SCS) request received from the non-AP STA; negotiate, when the SCS request is rejected by the AP, with the non-AP STA for enablement of an HIP EDCA feature.

Example B20 includes the apparatus of Example B17 or any other Examples herein, wherein the processor circuitry is further to: decode a Stream Classification Service (SCS) request for a traffic received from the non-AP STA; decode a traffic based on resource provided for the traffic after accepting the SCS request; allow, when a Quality of Service (QoS) requirement for the traffic is not satisfied, the HIP EDCA mechanism for the pending traffic.

Example B21 includes the apparatus of Example B17 or any other Examples herein, wherein the processor circuitry is further to: decode a modified Stream Classification Service (SCS) request received from the non-AP STA via the interface circuitry, wherein the modified SCS request is to request the AP to enable the HIP EDCA feature.

Example B22 includes the apparatus of Example B17 or any other Examples herein, wherein the processor circuitry is further to: decode a Stream Classification Service (SCS) request received from the non-AP STA via the interface circuitry, wherein the SCS request is to indicate whether to initiate the HIP EDCA mechanism or an SCS mechanism.

Example B23 includes the apparatus of Example B22 or any other Examples herein, wherein the SCS request includes a bit to indicate whether to initiate the HIP EDCA mechanism or an SCS mechanism; or the SCS request includes a profile to indicate whether to initiate the HIP EDCA mechanism or an SCS mechanism.

Example B24 includes the apparatus of Example B17 or any other Examples herein, wherein the processor circuitry is further to: establish a Stream Classification Service (SCS) stream between the non-AP STA and the AP for a traffic; and allow, when the SCS stream is torn down, the HIP EDCA mechanism for the traffic.

Example B25 includes the apparatus of any of Examples B19 to B24 or any other Examples herein, wherein the non-AP STA is a Multi-Link Device (MLD), and wherein the processor circuitry is further to: enable the SCS mechanism at an MLD level or a link level.

Example B26 includes the apparatus of any of Examples B19 to B24 or any other Examples herein, wherein the processor circuitry is further to: enable the SCS mechanism based on Access Category (AC) or Traffic Identifier (TID).

Example B27 includes the apparatus of Example B17 or any other Examples herein, wherein the non-AP STA is a Multi-Link Device (MLD), and wherein the processor circuitry is further to: enable the HIP EDCA mechanism at an MLD level or a link level.

Example B28 includes the apparatus of Example B17 or any other Examples herein, wherein the processor circuitry is further to: enable the HIP EDCA mechanism based on Access Category (AC) or Traffic Identifier (TID).

Example B29 includes a method for a non Access Point (non-AP) Station (STA), comprising: initiating a Higher-Priority (HIP) Enhanced Distributed Channel Access (EDCA) mechanism for a group of HIP EDCA capable STAs including the non-AP STA by transmitting a Defer Signal; and contending for channel access among the group of HIP EDCA capable STAs, wherein the initiation of the HIP EDCA mechanism is subject to a constraint of an AP associated with the non-AP STA.

Example B30 includes the method of Example B29 or any other Examples herein, further comprising: obtaining an HIP EDCA parameter advertised by the AP; and initiating the HIP EDCA mechanism following the HIP EDCA parameter.

Example B31 includes the method of Example B29 or any other Examples herein, further comprising: directly initiating, when the AP enables an HIP EDCA feature, the HIP EDCA mechanism for a traffic of a first Access Category (AC) if needed; or initiating, when the AP enables the HIP EDCA feature, the HIP EDCA mechanism for a traffic of a second AC via a modified Stream Classification Service (SCS) request, wherein the modified SCS request is to request the AP to enable the HIP EDCA feature for the traffic of the second AC.

Example B32 includes the method of Example B29 or any other Examples herein, further comprising: initiating a Stream Classification Service (SCS) mechanism with the AP via an SCS request; negotiating, when the SCS request is rejected by the AP, with the AP for enablement of an HIP EDCA feature.

Example B33 includes the method of Example B29 or any other Examples herein, further comprising: initiating a Stream Classification Service (SCS) mechanism via an SCS request for a traffic; causing transmission of the traffic via the SCS mechanism when the SCS request is accepted by the AP; initiating, when a Quality of Service (QoS) requirement for the traffic is not satisfied, the HIP EDCA mechanism for the pending traffic.

Example B34 includes the method of Example B29 or any other Examples herein, further comprising: initiating the HIP EDCA mechanism via a modified Stream Classification Service (SCS) request, wherein the modified SCS request is to request the AP to enable the HIP EDCA feature.

Example B35 includes the method of Example B29 or any other Examples herein, further comprising: encoding a Stream Classification Service (SCS) request for transmission to the AP, wherein the SCS request is to indicate whether to initiate the HIP EDCA mechanism or an SCS mechanism.

Example B36 includes the method of Example B35 or any other Examples herein, wherein the SCS request includes a bit to indicate whether to initiate the HIP EDCA mechanism or an SCS mechanism; or the SCS request includes a profile to indicate whether to initiate the HIP EDCA mechanism or an SCS mechanism.

Example B37 includes the method of Example B29 or any other Examples herein, further comprising: establishing a Stream Classification Service (SCS) stream between the non-AP STA and the AP for a traffic; and initiating, when the SCS stream is torn down, the HIP EDCA mechanism for the traffic.

Example B38 includes the method of any of Examples B31 to B37 or any other Examples herein, wherein the non-AP STA is a Multi-Link Device (MLD), and wherein the SCS mechanism is enabled at an MLD level or a link level.

Example B39 includes the method of any of Examples B31 to B37 or any other Examples herein, wherein the non-AP STA is a Multi-Link Device (MLD), and wherein the method further comprises: initiating the SCS mechanism at an MLD level or a link level.

Example B40 includes the method of any of Examples B31 to B37 or any other Examples herein, wherein the SCS mechanism is initiated based on Access Category (AC) or Traffic Identifier (TID).

Example B41 includes the method of Example B29 or any other Examples herein, wherein the initiation of the HIP EDCA mechanism is further subject to a constraint parameter which is predefined or configurable.

Example B42 includes the method of Example B29 or any other Examples herein, wherein the non-AP STA is a Multi-Link Device (MLD), and wherein the HIP EDCA mechanism is enabled at an MLD level or a link level.

Example B43 includes the method of Example B29 or any other Examples herein, wherein the non-AP STA is a Multi-Link Device (MLD), and wherein the method further comprises: initiating the HIP EDCA mechanism at an MLD level or a link level.

Example B44 includes the method of Example B29 or any other Examples herein, wherein the HIP EDCA mechanism is initiated based on Access Category (AC) or Traffic Identifier (TID).

Example B45 includes a method for an Access Point (AP), comprising: enabling a Higher-Priority (HIP) Enhanced Distributed Channel Access (EDCA) mechanism; decoding a traffic received from a non-AP Station (STA) associated with the AP, wherein the traffic is transmitted by the non-AP STA via the HIP EDCA mechanism.

Example B46 includes the method of Example B45 or any other Examples herein, further comprising: advertising an HIP EDCA parameter to allow the non-AP STA to perform the HIP EDCA mechanism following the HIP EDCA parameter.

Example B47 includes the method of Example B45 or any other Examples herein, further comprising: decoding a Stream Classification Service (SCS) request received from the non-AP STA; negotiating, when the SCS request is rejected by the AP, with the non-AP STA for enablement of an HIP EDCA feature.

Example B48 includes the method of Example B45 or any other Examples herein, further comprising: decoding a Stream Classification Service (SCS) request for a traffic received from the non-AP STA; decoding a traffic based on resource provided for the traffic after accepting the SCS request; allowing, when a Quality of Service (QoS) requirement for the traffic is not satisfied, the HIP EDCA mechanism for the pending traffic.

Example B49 includes the method of Example B45 or any other Examples herein, further comprising: decoding a modified Stream Classification Service (SCS) request received from the non-AP STA, wherein the modified SCS request is to request the AP to enable the HIP EDCA feature.

Example B50 includes the method of Example B45 or any other Examples herein, further comprising: decoding a Stream Classification Service (SCS) request received from the non-AP STA, wherein the SCS request is to indicate whether to initiate the HIP EDCA mechanism or an SCS mechanism.

Example B51 includes the method of Example B50 or any other Examples herein, wherein the SCS request includes a bit to indicate whether to initiate the HIP EDCA mechanism or an SCS mechanism; or the SCS request includes a profile to indicate whether to initiate the HIP EDCA mechanism or an SCS mechanism.

Example B52 includes the method of Example B45 or any other Examples herein, further comprising: establishing a Stream Classification Service (SCS) stream between the non-AP STA and the AP for a traffic; and allowing, when the SCS stream is torn down, the HIP EDCA mechanism for the traffic.

Example B53 includes the method of any of Examples B47 to B52 or any other Examples herein, wherein the non-AP STA is a Multi-Link Device (MLD), and wherein the method further comprises: enabling the SCS mechanism at an MLD level or a link level.

Example B54 includes the method of any of Examples B47 to B52 or any other Examples herein, further comprising: enabling the SCS mechanism based on Access Category (AC) or Traffic Identifier (TID).

Example B55 includes the method of Example B45 or any other Examples herein, wherein the non-AP STA is a Multi-Link Device (MLD), and wherein the method further comprises: enabling the HIP EDCA mechanism at an MLD level or a link level.

Example B56 includes the method of Example B45 or any other Examples herein, further comprising: enabling the HIP EDCA mechanism based on Access Category (AC) or Traffic Identifier (TID).

Example B57 includes a computer-readable medium having instructions stored thereon, wherein the instructions, when executed by processing circuitry, cause the processing circuitry to perform the method of any of Examples B29-B44 or any other Examples herein.

Example B58 includes a computer-readable medium having instructions stored thereon, wherein the instructions, when executed by processing circuitry, cause the processing circuitry to perform the method of any of Examples B45-B56 or any other Examples herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An apparatus for a non Access Point (non-AP) Station (STA), comprising:
interface circuitry; and
processor circuitry coupled with the interface circuitry,
wherein the processor circuitry is to:
encode a first frame for transmission to an AP associated with the non-AP STA via the interface circuitry, wherein the first frame is to indicate an extended Queue size for a Traffic Identifier (TID) to request a resource assigned for a traffic corresponding to the TID;
decode a second frame received from the AP via the interface circuitry in response to the first frame to obtain the resource assigned for the traffic; and
cause transmission of the traffic to the AP with the assigned resource.

2. The apparatus of claim 1, wherein the first frame includes a first field to indicate the TID and an extended Unscaled Value (UV) corresponding to the TID and a second field to indicate the TID and a Scaling Factor (SF), and wherein the extended Queue size for the TID is based on the extended UV and the SF.

3. The apparatus of claim 1, wherein the first frame is to indicate the extended Queue size for the TID and the TID within a single field.

4. The apparatus of claim 3, wherein the single field includes a TID subfield to indicate the TID, an extended Unscaled Value (UV) subfield to indicate an extended UV corresponding to the TID, and a Scaling Factor (SF) subfield to indicate an SF, and wherein the extended Queue size for the TID is based on the extended UV and the SF.

5. The apparatus of claim 3, wherein the single field includes a TID subfield to indicate the TID and an airtime subfield to indicate an airtime corresponding to the TID, and wherein the extended Queue size for the TID is based on the airtime.

6. The apparatus of claim 3, wherein the single field includes a TID subfield to indicate the TID, an Unscaled Value (UV) subfield to indicate a UV corresponding to the TID, and a Scaling Factor (SF) subfield to indicate a scaled up SF, and wherein the extended Queue size for the TID is based on the UV and the scaled up SF.

7. The apparatus of claim 3, wherein the single field includes a TID subfield to indicate the TID, an Unscaled Value (UV) subfield to indicate a UV corresponding to the TID, and a Scaling Factor (SF) subfield to indicate an SF, and wherein the extended Queue size for the TID is based on an unspecified combination of the UV and the SF.

8. The apparatus of claim 1, wherein the first frame includes a first field to indicate an extended Unscaled Value (UV) corresponding to the TID, and a second field to indicate the TID and a Scaling Factor (SF), and wherein the extended Queue size for the TID is based on the extended UV and the SF.

9. The apparatus of claim 1, wherein the processor circuitry is further to:
aggregate a plurality of Media Access Control (MAC) Protocol Data Units (MPDUs) to obtain an Aggregated MPDU (A-MPDU), wherein at least one of the plurality of MPDUs is in the format of the first frame; and
cause transmission of the A-MPDU to the AP via the interface circuitry.

10. An apparatus for an Access Point (AP), comprising:
interface circuitry; and
processor circuitry coupled with the interface circuitry,
wherein the processor circuitry is to:
decode a first frame received from a non-AP Station (STA) associated with the AP via the interface circuitry, wherein the first frame is to indicate an extended Queue size for a Traffic Identifier (TID) to request a resource assigned for a traffic corresponding to the TID;
determine the resource assigned for the traffic based on the extended Queue size; and
encode, in response to the first frame, a second frame for transmission to the non-AP STA via the interface circuitry to indicate the resource assigned for the traffic.

11. The apparatus of claim 10, wherein the first frame includes a first field to indicate the TID and an extended Unscaled Value (UV) corresponding to the TID and a second field to indicate the TID and a Scaling Factor (SF), and wherein the processor circuitry is further to:
determine the extended Queue size for the TID based on the extended UV and the SF.

12. The apparatus of claim 10, wherein the first frame is to indicate the extended Queue size for the TID and the TID within a single field, the single field includes a TID subfield to indicate the TID, an extended Unscaled Value (UV) subfield to indicate an extended UV corresponding to the TID, and a Scaling Factor (SF) subfield to indicate an SF, and wherein the processor circuitry is further to:
determine the extended Queue size for the TID based on the extended UV and the SF.

13. The apparatus of claim 10, wherein the first frame is to indicate the extended Queue size for the TID and the TID within a single field, the single field includes a TID subfield to indicate the TID and an airtime subfield to indicate an airtime corresponding to the TID, and wherein the processor circuitry is further to:
determine the extended Queue size for the TID based on the airtime.

14. The apparatus of claim 10, wherein the first frame is to indicate the extended Queue size for the TID and the TID within a single field, the single field includes a TID subfield to indicate the TID, an Unscaled Value (UV) subfield to indicate a UV corresponding to the TID, and a Scaling Factor (SF) subfield to indicate a scaled up SF, and wherein the processor circuitry is further to:
determine the extended Queue size for the TID based on the UV and the scaled up SF.

15. The apparatus of claim 10, wherein the first frame is to indicate the extended Queue size for the TID and the TID within a single field, the single field includes a TID subfield to indicate the TID, an Unscaled Value (UV) subfield to indicate a UV corresponding to the TID, and a Scaling Factor (SF) subfield to indicate an SF, and wherein the processor circuitry is further to:
determine the extended Queue size for the TID based on an unspecified combination of the UV and the SF.

16. The apparatus of claim 10, wherein the first frame includes a first field to indicate an extended Unscaled Value (UV) corresponding to the TID, and a second field to indicate the TID and a Scaling Factor (SF), and wherein the processor circuitry is further to:
determine the extended Queue size for the TID based on the extended UV and the SF.

17. The apparatus of claim 10, wherein the first frame includes a data frame or a management frame.

18. The apparatus of claim 10, wherein the processor circuitry is further to:
decode an Aggregated Media Access Control (MAC) Protocol Data Units (MPDU) (A-MPDU) to obtain a plurality of MPDUs, wherein at least one of the plurality of MPDUs is in the format of the first frame; and
determine resource assigned for corresponding traffic based on the extended Queue size indicated by the corresponding MPDU.

19. A computer-readable medium having instructions stored thereon, wherein the instructions, when executed by processing circuitry, cause the processing circuitry to:
encode a first frame for transmission to an Access Point (AP), wherein the first frame is to indicate an extended Queue size for a Traffic Identifier (TID) to request a resource assigned for a traffic corresponding to the TID;
decode a second frame received from the AP in response to the first frame to obtain the resource assigned for the traffic; and
cause transmission of the traffic to the AP with the assigned resource.

20. The computer-readable medium of claim 19, wherein the first frame includes a first field to indicate the TID and an extended Unscaled Value (UV) corresponding to the TID and a second field to indicate the TID and a Scaling Factor (SF), and wherein the extended Queue size for the TID is based on the extended UV and the SF.
